(19) United States
(12) Patent Application Publication
(10) Pub. No.: US 2009/0134187 A1
(43) Pub. Date: May 28, 2009

(54) Ejection device

(75) Inventor: Christian Hefele, Breitenbrunn (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/291,324

(22) Filed: Nov. 6, 2008

(30) Foreign Application Priority Data
Nov. 26, 2007 (DE) 10 2007 057 111.0

(51) Int. Cl. B67D 5/42

(52) U.S. Cl. 222/391

(57) ABSTRACT

An ejection device (11) for containers containing compounds has a receiving chamber (12) for the container, a piston rod (13) which is displaceable relative to the receiving chamber (12), and an ejection unit (16) having a housing (17), a forward feed element (18) which is pivotally supported in the housing (17) for advancing the piston rod (13), and a handle (19) with an actuation lever (21) which is pivotal around an axis of rotation (22) and which has an effort arm (25) with a hand grip and a load arm (24). Pressure transmission means (23) is provided at the end of the load arm (24) facing the forward feed element (18) and can be brought into contact with the forward feed element for actuating the forward feed element (18). The length (L1) of the load arm (24), which is determined by a distance from the pressure transmission means (23) to the axis of rotation (22) of the actuation lever (21), is adjustable by displacing a bearing pin (31) that forms the axis of rotation of the actuation lever, in a guide slot provided in the actuation lever (21).

### BACKGROUND OF THE INVENTION

1. Field of the Invention

The present invention relates to an ejection device for containers containing compounds and having a receiving chamber for the container, at least one piston rod displaceable relative to the receiving chamber, and an ejection unit including a housing, at least one forward feed element pivotally supported in the housing for advancing the piston rod, a handle with an actuation lever pivotable about an axis of rotation, and with pressure transmission means at the end of the load arm facing the forward feed element for actuating the forward feed element, the pressure transmission means being capable of being brought into contact with the forward feed element, and with the length of the load arm, which is determined by distance between the pressure transmission means and the axis of rotation of the actuation lever, being adjustable.

2. Description of the Prior Art

An ejection device of the type mentioned above is used for dispensing compounds, such as mortar compounds or sealing compounds, which are packaged in containers, at an application site. Containers are, for example, cartridges with one or more receiving chambers for one or more components of the compound to be applied which are provided directly or packaged, e.g., in foil bags, in the receiving chambers of the cartridge. The expression “container” further includes foil bags which are filled with one or more components of the compound to be applied and inserted in a separate receiving body or in a receiving body arranged at the ejection device.

When the actuation lever is actuated, the pressure transmission means acts on the forward feed element so that the piston rod is displaced by a predetermined amount. For example, a pressure piston arranged at the piston rod acts on the compound located in the container so that a corresponding amount of the compound is dispensed through the dispensing opening with every advance of the piston rod.

The ratio of length of the load arm of the actuation lever, which is defined by a distance between the axis of rotation of the actuation lever and the pressure transmission means, and the length of the effort arm, which is determined by distance between the axis of rotation of the actuation lever and the grip portion of the effort arm at which the user actuates the actuation lever by hand, determines the lever ratio of the two arms of the actuation lever. Different forward feed forces are advantageous for dispensing the compounds contained in the container, depending on the kind of compound to be applied or on external influences. The ejection device can dispense more compound within the same amount of time by generating forward feed forces which are higher than the actual forward feed forces. When the force required for actuating the lever is high in order to apply the necessary forward feed forces for dispensing the compound, this can very quickly lead to fatigue in the user.

U.S. Pat. No. 5,197,635 discloses an ejection device for containers containing compounds which has an actuation lever with a pivoting point that is fixed with respect to the housing. In order to adjust different lever ratios, an element which is arranged so as to be displaceable in a guide and which has pressure transmission means is provided at the end of the load arm of the actuation lever facing the forward feed element. The pressure transmission means acts on the forward feed element when the actuation lever is actuated. The element with the pressure transmission means can be fixed in a desired position by a clamping bolt.

The known solution is disadvantageous in that a tool is required for displacing the bearing element and, therefore, for adjusting the transmission ratio, and the housing must be opened.

### SUMMARY OF THE INVENTION

It is the object of the invention to provide an ejection device for different compounds in which the lever ratio can be adapted by the user, as needed, but which has a simple construction.

According to the invention, there are provided a guide slot and at least one bearing pin forming the axis of rotation of the actuation lever, with the bearing pin being displaceable along the guide slot in order to adjust the length of the load arm.

The length of the load arm can be varied in at least two positions, with the ends of the guide slot limiting the maximum adjustability of the bearing pin relative to the housing of the ejection unit. On the one hand, a short load arm can be provided, by which the compound is dispensed with the high required force at the forward feed element with comfortable manual force and a short forward feed. On the other hand, a longer load arm can be provided, which enables a faster application of the compound with a lower force requirement at the forward feed element because larger amounts of the compound are delivered per stroke or with every actuation of the actuation lever. The user can adapt the transmission ratio as needed at any time and without any auxiliary means and can, accordingly, determine the force exerted on the forward feed element. The pressure transmission means is formed as a surface or an edge, for example.

The guide slot is advantageously provided at the actuation lever of the handle. Accordingly, the at least one bearing pin forming the axis of rotation of the actuation lever is provided in or at the housing of the ejection unit. This facilitates operation and allows the adjusting mechanism to be constructed in a simple manner so that the ejection device can be constructed and produced economically.

The bearing pin is preferably spring loaded for being fixed in the guide slot so that the actuation lever is fixed with a determined lever ratio. When the actuation lever is deflected counter to the spring force, advantageously counter to the actuation direction of the effort arm, the bearing pin is released and the actuation lever is displaceable for adjusting a different lever ratio. When the desired lever ratio of the actuation lever has adjusted the transmission ratio, the actuation lever, when released, is pulled to the limit of the guide slot again by the spring force and is, accordingly, fixed in this position.

At least two bearing seats for the at least one bearing pin are preferably provided in the guide slot and define at least two different lever ratios of the actuation lever. The bearing seats ensure a simple operation of the ejection device because the bearing pin, forming the axis of rotation, is held securely in the bearing seats until the actuation lever is repositioned, particularly when the bearing pin is spring loaded.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side view of an ejection device according to the present invention;

FIG. 2 a partial cross-sectional view of an ejection unit along line II-II in FIG. 1, with an actuation lever in a first position; and

FIG. 3 a partial cross-sectional view of another embodiment of the ejection unit similar to FIG. 2, with the actuation lever in a second position.

In principle, in the drawings, identical parts are provided with identical reference numerals.

### DETAILED DESCRIPTION OF THE PREFERRED EMBODIMENTS

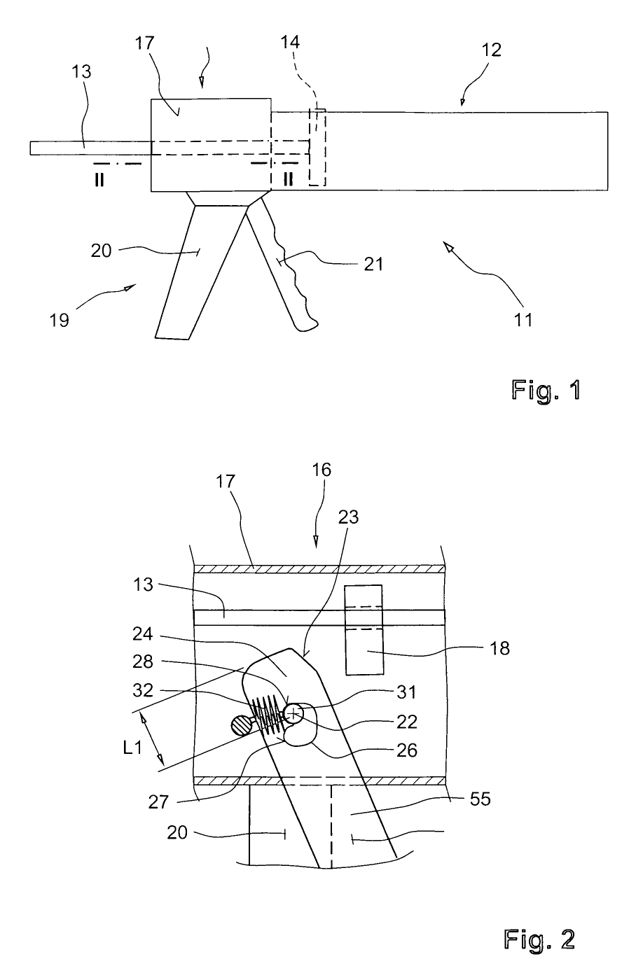

The ejection device 11 for containers containing compounds which is shown in FIGS. 1 and 2, has a receiving chamber 12 for the container, a piston rod 13 which is displaceable relative to the receiving chamber 12 and at an end of which adjacent to the receiving chamber 12, a pressure piston 14 is provided for acting upon the container, and an ejection unit 16.

The ejection unit 16 has a housing 17, a forward feed element 18 which is pivotally supported in the housing 17 for advancing the piston rod 13, a handle 19 with a stationary hand grip 20, and an actuation lever 21 which is pivotal around an axis of rotation 22. The actuation lever 21 has an effort arm 25 with a hand grip section and a load arm 24. Pressure transmission means 23, which can be brought into contact with the forward feed element 18, is provided at the end of the load arm 24 facing the forward feed element 18 for actuating the forward feed element 18. In order to change the lever ratio, the axis of rotation 22 of the actuation lever 21, and therefore, the entire actuation lever 21, is displaceable relative to the housing 17 of the ejection unit 16. The length L1 of the load arm 24 from the pressure transmission means 23 to the axis of rotation 22 of the actuation lever 21 is adjustable. A guide slot 26 is provided at the actuation lever 21 of the handle 19 and a bearing pin 31 which is guided along the guide slot 26 and forms the axis of rotation 22 is provided in the housing 17. The guide slot 26 has a bearing seat 27 and 28, respectively, for the bearing pin 31 at each of its ends. The bearing pin 31 is acted upon by a helical spring 32 for fixing in the guide slot 26. The engagement of the bearing pin 31 in the bearing seat 27 is canceled by a swiveling movement of the effort arm 25 of the actuation lever 21 in the counterclockwise direction, as shown in FIG. 2, and the actuation lever 21 can be displaced for adjusting another transmission ratio.

When the actuation lever 21 is actuated, the piston rod 13 with the pressure piston 14 is displaced by the forward feed element 18, and the component or components of the compound located in the container are dispensed, e.g., through a mixing housing, at the desired application site. In this position of the actuation lever 21, a short load arm 24 with length L1 is adjusted, by which the compound is dispensed with a comfortable manual force and short forward feed with a high required force at the forward feed element 18 and for dispensing the compound.

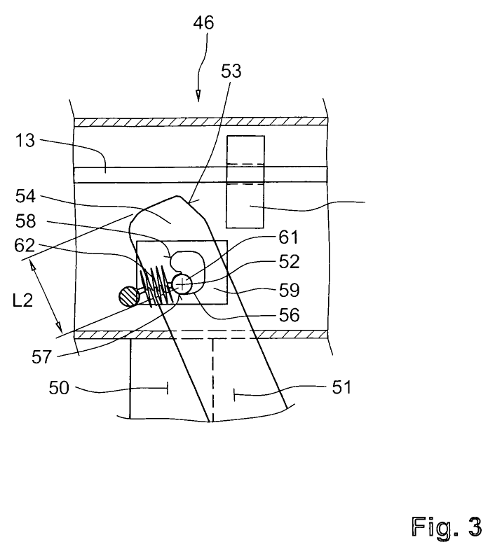

FIG. 3 shows a sectional view of an ejection device 41 with an ejection unit 46 in which the guide slot 56 is provided in a separate element 59 which is connected to the housing (not shown), and the bearing pin 61 forms the axis of rotation 52 at the actuation lever 51. The bearing pin 61 is held in the bearing seats 57 and 58, respectively, so as to be loaded by the helical spring 62. The axis of rotation 52 of the actuation lever 51 is displaceable relative to the housing 47 of the ejection unit 46 for changing the lever ratio. In this position of the actuation lever 51 shown in the drawing, a longer load arm 54 with length L2 is adjusted, by which the compound is dispensed faster with a small force requirement at the forward feed element 48 and for dispensing the compound because larger quantities of the compound are dispensed per stroke. The length of the effort arm 55 from the axis of rotation 22 to the grip portion of the effort arm 55 is shorter than in the position of the actuation lever 51 (not shown here) corresponding to that shown in FIG. 2.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. An ejection device for containers containing compounds, comprising a receiving chamber (12) for the container; at least one piston rod (13) which is displaceable relative to the receiving chamber (12); and an ejection unit (16; 46) having a housing (17; 47), at least one forward feed element (18; 48) which is pivotally supported in the housing (17; 47) for advancing the piston rod (13), and a handle (19) with an actuation lever (21; 51) which is pivotal around an axis of rotation (22; 52) and which has an effort arm (25; 55) with a hand grip section and a load arm (24; 54), pressure transmission means (23; 53) provided at the end of the load arm (24; 54) facing the forward feed element (18; 48) and which can be brought into contact with the forward feed element (18; 48), for actuating the forward feed element (18; 48), and means for adjusting a length (L1; L2) of the load arm (24; 54), which is determined by a distance from the pressure transmission means (23; 53) to the axis of rotation (22; 52) of the actuation lever (21; 51), the adjusting means having a guide slot (26; 56) and at least one bearing pin (31; 61) which forms the axis of rotation (22; 52) of the actuation lever (21; 51) and is displaceable along the guide slot (26; 56) to adjust the length (L1′ L2) of the load arm (24; 54).

2. An ejection device according to claim 1, wherein the guide slot (26) is provided on the actuation lever (21) of the handle (19).

3. An ejection device according to claim 1, wherein the bearing pin (31; 61) is spring loaded for being fixed in the guide slot (26; 56).

4. An ejection device according to claim 1, wherein at least two bearing seats (27, 28; 57, 58) for the bearing pin (31; 61) are provided in the guide slot (26; 56).
